(19) United States
(12) Patent Application Publication
(10) Pub. No.: US 2002/0069963 A1
(43) Pub. Date: Jun. 13, 2002

(54) Method and apparatus for producing papers with contact adhesive

(76) Inventor: Martin Bluemle, Horhausen (DE)

Correspondence Address: FASSE PATENT ATTORNEYS, P.A., P.O. BOX 726, HAMPDEN, ME, 04444-0726, US

(21) Appl. No.: 09/916,492

(22) Filed: Jul. 26, 2001

(30) Foreign Application Priority Data
Jul. 28, 2000 (DE) 100 37 028.4

(51) Int. Cl. B05B 1/00

(52) U.S. Cl. 156/289; 156/278

(57) ABSTRACT

The invention relates to methods of producing papers with contact adhesive along edge strips on their one side, paper blanks being given a coating on both sides and, on one side, additionally a coating with the contact adhesive on the coating.

The nub of the invention is that the paper blanks, during continuous transport, are initially staggered, provided with a coating, preferably an anti-adhesion coating, on a first side, are then separated, are then led around a deflection point, then staggered again in the new transport direction, then provided on the second side with a coating, preferably with a primer, and finally coated on one of the two sides with the contact adhesive.

### DESCRIPTION

The invention relates to a method and an apparatus for producing papers with contact adhesive according to the features of the preamble of patent claim 1.

In general, the invention relates to a method and an apparatus for the continuous application of viscous substrates on both sides to edge strips at the same end but on opposite sides of a moving blank or paper blank. Methods and apparatuses of this type are needed for producing paper blocks with pieces of paper which can be pulled off and stuck on again at any desired locations, or for preparing papers which are arranged on rolls and can be transferred from the latter to any desired locations on another carrier material, such as to the sides of a folder or the like.

It is known to supply the paper blanks to individual processing stations and, in order to coat them with an anti-adhesion coating or adhesive coating on edge strips of both sides, to turn them at a deflection point and then to stop them and transport them onward parallel to the original direction. Although this working process is feasible and secure in terms of handling, the numbers per unit time can no longer be increased substantially. The invention is therefore based on the object of providing measures with which it is possible to achieve higher numbers per unit time.

In order to achieve this object, the invention having the features of the characterizing part of patent claim 1 provides for the paper blanks to be staggered during continuous transport, provided with a first coating, preferably an anti-adhesion coating, on a first side, then separated, then led around a deflection point, then staggered again in the new transport direction, then provided on the second side with a second coating, preferably a primer, and finally coated on one of the two sides with the contact adhesive, and for the contact adhesive—if necessary—to be dried. Primer is a type of adhesive base for improving the contact adhesive (adhesion promoter).

This procedure permits continuous transport without a stopping point, and also permits a compact design of the apparatus. The apparatus is therefore capable of operating extraordinarily quickly and with large numbers per unit time.

Since the coating is, as a rule, an aqueous dispersion, in each case a drying station is provided after each device for applying the coating.

Further features of the invention emerge from subclaims in conjunction with the description and the drawing.

The invention will be described in more detail below using two exemplary embodiments, which are illustrated in the drawing, in which:

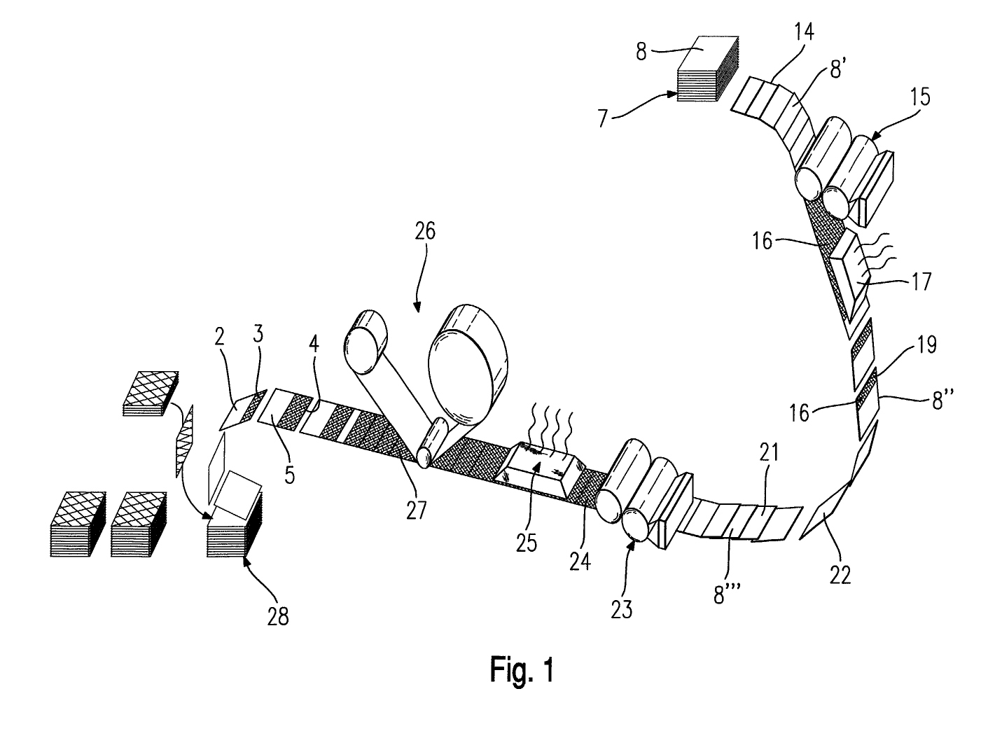

FIG. 1 shows a perspective schematic representation of the method steps;

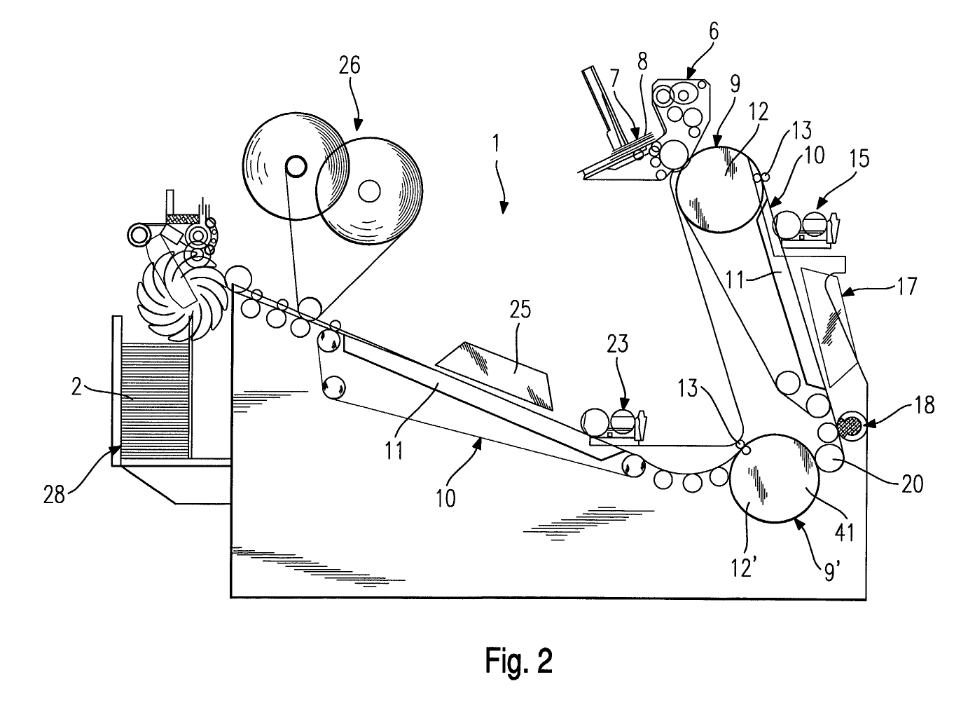

FIG. 2 shows a side view of a schematic representation of an apparatus with an individual sheet store,

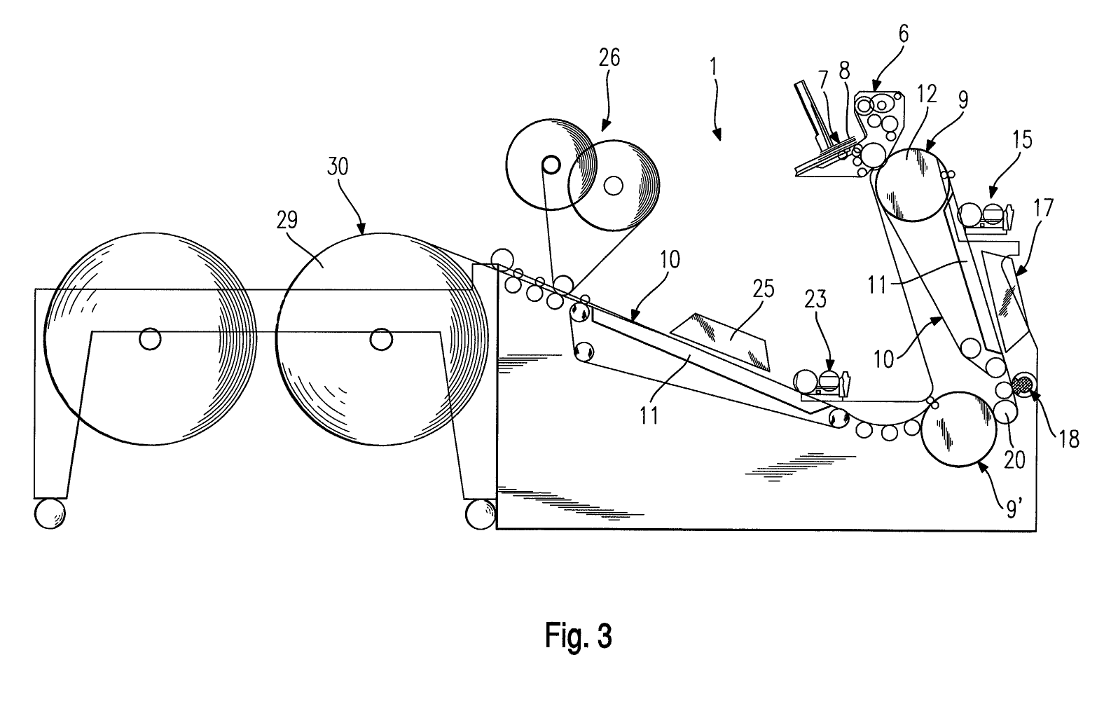

FIG. 3 shows a view like that in FIG. 2 of an apparatus with a roll store, and

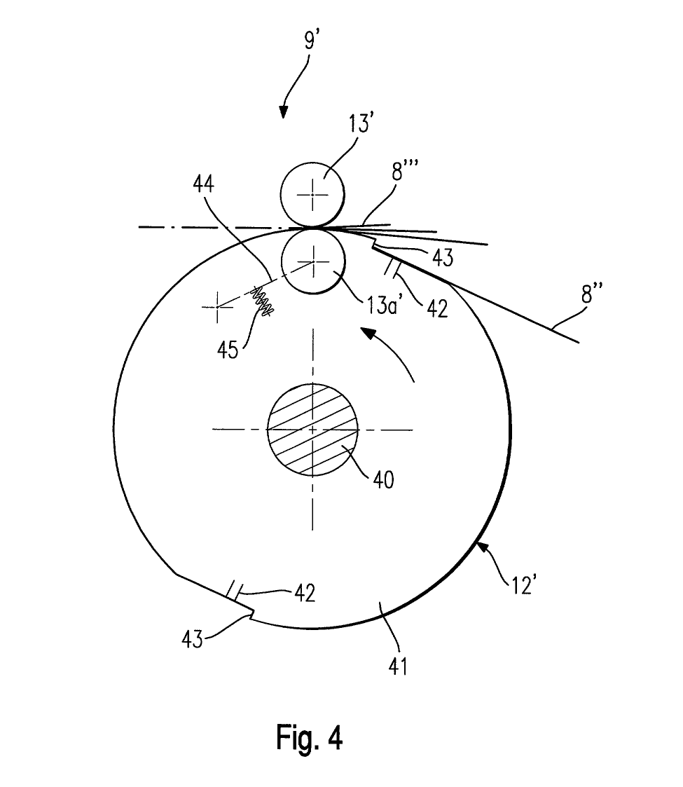

FIG. 4 shows a staggering device.

An apparatus 1 for producing papers 2 with contact adhesive 3 along an edge strip 4 on its one side 5, respectively, comprises, as an input station according to the exemplary embodiments represented in the figures, a separating device or a sheet feed 6, which is known in principle and which, for example, outputs paper blanks 8 initially arranged as a stack 7 to a device 9, likewise known in principle, to be deposited or arranged staggered on a transport base 10.

According to the exemplary embodiment, the transport base 10 comprises suction rolls and transport belts, which either have suction openings or run at a distance from one another over suction boxes 11, so that the product to be processed is in each case held on them by vacuum.

The device 9, which is known in principle, for the staggered arrangement of the paper blanks 8 on the transport base 10 comprises a staggering wheel 12 and staggering rollers 13. A device 9 of this type is illustrated and described, for example, in FIG. 4 and in DE 1183774.

The paper blanks 8′, arranged in a staggered position with an overlap width 14 on the transport base 10, are firstly fed, according to FIG. 1, to a device 15 for applying a coating 16 (anti-adhesion coating, release). This coating 16 may be an aqueous dispersion or it is a viscous substrate which, according to the exemplary embodiment illustrated in the figures, is dried in the next working step. For this purpose, the transport base 10 transports the coated paper blanks 8′ lying staggered past a station 17 in which the anti-adhesion coating 16 is dried by supplying heat.

After the drying, the paper blanks 8′ lying staggered are separated. For this purpose, use is made of a device 18, which is known in principle and which, for example, is disclosed by DE 196 09 991 or DE-B 1073288.

After being separated, the paper blanks 8″, each having a coating 16 on one edge strip 19, are moved around a deflection point 20. This deflection point is, for example, a deflection roller.

Then, the separated paper blanks 8″ are arranged in a staggered position on the transport base 10, with the aid of a second device 9′ (see FIG. 4), in such a way that edge strips 21, which may correspond to the edge strips 4 mentioned above, on the second side 22 (may correspond to the side 5) of the paper blanks 8″′ are freely accessible to a second device 23 for applying a coating 24, preferably a primer (adhesion promoter). Here, too, the coating 24 is, as a rule, an aqueous dispersion and must be dried. For this purpose, a device or station 25 is used, using which appropriate heat is supplied to the paper blanks 8″′.

Downstream, in the transport direction, of the station 25 used for drying there is finally arranged yet another device 26, with the aid of which contact adhesive 27 is applied to the coating 24 (primer) applied last and dried. During the application of the contact adhesive 27, the paper blanks 8″′ are still arranged in a staggered position on the transport base 10.

After the application of the contact adhesive 27, the finished papers 2 are separated and then either deposited in accordance with FIGS. 1 and 2 and, for example, stacked as a block 28 or, according to FIG. 3, are wound up with the aid of carrier material 29 to form a roll 30.

For the twofold staggering of the paper blanks, it is essential that the second staggering is carried out in such a way that the respectively exposed edge strips on the different sides of the paper blanks are arranged at respectively the same ends of the paper blanks.

A device 9 or 9′ for staggering paper blanks 8 comprises a staggering wheel 12 or 12′ and staggering rollers 13 or 13′. The staggering wheel 12 is arranged on a shaft 40 and rotates at a peripheral speed which corresponds to the speed at which the separated blanks 8, 8″ are transported. The staggering wheel comprises a plurality of staggering disks 41 arranged at intervals from one another and, according to the exemplary embodiment illustrated in FIG. 4, has suction holes 42 located diametrically opposite each other and, leading in the direction of rotation, a stop 43 in each case. In addition, the staggering rollers 13 and 13′ are in each case assigned in pairs to the staggering disks 41. The staggering rollers 13 and 13′ are located in the gaps between the staggering disks 41. The staggering rollers 13 and 13′ rotate at a peripheral speed which corresponds to the transport speed of the blanks 8″′ arranged staggered. By means of the staggering rollers 13′, the individually arriving paper blanks 8 and 8″ are braked, one staggering roller 13 or 13a′ located radially on the inside being pivotally mounted on an arm 44 and being acted on by a spring 45 in such a way that it presses the paper blanks against the other staggering roller 13 or 13′.

The staggering disks 41 are firmly connected to the shaft or drive shaft 40 so as to rotate with it, and transport the blanks 8 or 8″, by means of the suction force on the suction holes 42, in each case as far as the staggering rollers 13 or 13′. There, the staggering wheel or its staggering disks 41 release the paper blanks 8, 8″, so that the staggering rollers perform both the staggering and the onward transport.

1. Method of producing papers (2) with contact adhesive (3) along edge strips (4) on their one side (5), paper blanks (8) being given a coating (16, 24), preferably an anti-adhesion coating or primer, on both sides, and on one side (5), in addition, a coating with the contact adhesive (3) on the coating (16 or 24), characterized
a) in that the paper blanks (8) are initially staggered during continuous transport,
b) provided with a coating (16), preferably an anti-adhesion coating, on a first side,
c) are then separated,
d) are then led around a deflection point (20),
e) are then staggered again in the new transport direction,
f) are then likewise provided with a coating (24), preferably a primer, on the second side (5 or 22) and
g) are finally coated on one of the two sides with the contact adhesive (3, 27), and
h) in that the contact adhesive (3, 27) is dried if necessary.

2. Method according to claim 1, characterized in that the contact adhesive (27) is applied to the coating (24) on the second side (5 or 22).

3. Method according to claim 1, characterized in that the coating (16, 24) is preferably dried with heat in each case after the application.

4. Method according to claims 1-3, characterized in that the papers (2), after being coated, are stacked as a block (28) or wound up with a carrier material (29) to form a roll (30).

5. Method according to claim 1, characterized in that the second staggering of the paper blanks (8) is carried out in such a way that an edge strip (21) at the same end of the paper blank (8) is freely accessible for coating as in the case of the edge strip (19).

6. Apparatus for producing papers (2) with contact adhesive (3) along edge strips (4, 21) on their one side (5), paper blanks (8) being given a coating (16 and 24) on both sides and, on one side (5), additionally being given a coating with the contact adhesive (3) on the coating (16 or 24), characterized by
a) a device (9) for the staggered arrangement of the paper blanks (8) on a transport base (10),
b) a device (15) for applying a coating (16) to the exposed edge strips (19) of the paper blanks (8′) arranged staggered,
c) a device (18) for separating the paper blanks (8′) arranged staggered,
d) a deflection point (20) for the paper blanks (8″) arranged separated,
e) a further device (9′) for the staggered arrangement of the blanks (8″′) with a mirror-image, identical overlapping position of the second side (22) of the paper blanks (8″′) to that initially on the first side (5),
f) a device (23) for applying a coating (24) to the blanks (8″′) on the second side (22), and
g) a device (26) for applying a contact adhesive (27) to the coating (16 or 24) on one of the two sides of the paper blank (8).

7. Apparatus according to claim 6, characterized in that in each case a station (17) or (25) for drying the coating (16 or 24) is arranged in the transport direction behind the respective device (15 or 23) for applying the coating (16 or 24).
